(19) United States
(12) Patent Application Publication
(10) Pub. No.: US 2026/0338257 A1
(43) Pub. Date: Oct. 29, 2026

(54) Planetary Gearing

(71) Applicant: WITTENSTEIN SE, Igersheim (DE)

(72) Inventors: Andreas Kümmeth, Obernbreit (DE); Michael Schmidt, Reichenberg (DE); Franziska Lux, Würzburg (DE); Alexander Drechsel, Würzburg (DE)

(73) Assignee: WITTENSTEIN SE, Igersheim (DE)

(21) Appl. No.: 19/662,241

(22) Filed: Apr. 29, 2026

(30) Foreign Application Priority Data
Apr. 29, 2025 (DE) 102025116527.0

(51) Int. Cl. F16H 1/28; F16H 57/08

(52) U.S. Cl. CPC F16H 1/28; F16H 57/08

(57) ABSTRACT

A planetary gearing (1, 201) includes a ring gear (3, 203) with a ring gear tooth count z_{H}, a sun gear (5, 205) rotatable about a gearing rotation axis (17) of the planetary gearing (1) with a sun gear tooth count z_{S}, a number N of planet gears (207) with planet rotation axes (19), wherein the planet rotation axes (19) are arranged at angular positions φₙ distributed unevenly in the circumferential direction around the gearing rotation axis (17), wherein the angular positions φₙ are determined by the formula

$${φ}_{n} = round ( n \cdot \frac{{z}_{S} - {z}_{H}}{N} ) \cdot \frac{360 °}{{z}_{S} - {z}_{H}}$$

for n=1 to N, wherein the function round( ) specifies rounding to integers [symbol] .

### BACKGROUND OF THE INVENTION

The disclosure relates to a planetary gearing, a kit for a plurality of planetary gearings, and a method for assembling at least one planetary gearing.

Planetary gearings with uniform or non-uniform distribution of planet gears around a gearing rotation axis of a planetary gearing are known from the prior art. An uneven distribution of planet gears typically results in varying loads on the planet gears and their bearings. However, an uneven distribution of planet gears can be advantageous, for example, in the manufacture of planetary gearings with different gear ratios from a modular gearing system, particularly to reduce the number of different components.

However, known planetary gearings, in particular known planetary gearings with an uneven distribution of the planet gears, have limitations, for example with regard to load-carrying capacity, vibration behavior, or wear of the planetary gearings.

### SUMMARY OF THE INVENTION

The objective of the disclosure is to provide a planetary gearing, a kit for a plurality of planet gears, and a method for assembling at least one planet gear, which are improved over the prior art. In particular, a planetary gearing should be disclosed that exhibits high load-carrying capacity, low vibration excitation, low noise generation, or low wear.

The object is achieved by a planetary gearing and a kit and a method all as disclosed herein.

According to one aspect, a planetary gearing is specified. The planetary gearing comprises a ring gear with a ring gear tooth count z_{H}. The planetary gearing comprises a sun gear rotatable about a gearing rotation axis of the planetary gearing with a sun gear tooth count z_{S}. The planetary gearing comprises a number N of planet gears with planet axes, wherein the planet axes are arranged in the circumferential direction at angular positions φₙ, wherein the angular positions φₙ are determined by the formula

$${φ}_{n} = round ( n \cdot \frac{{z}_{S} - {z}_{H}}{N} ) \cdot \frac{360 °}{{z}_{S} - {z}_{H}}$$

for n=1 to N, wherein the function round( ) specifies rounding to integers [symbol] .

According to a further aspect, a kit for a plurality of planetary gearings is provided, the plurality of planetary gearings comprising a first planetary gearing, which is to be assembled as a planetary gearing according to one of the embodiments described herein. The kit comprises ring gears for the plurality of planetary gearings, wherein the ring gears each have the same ring gear tooth count z_{H} The kit comprises a first sun gear with the first sun gear tooth count z_{S} for the first planetary gearing. The kit comprises a first planet gear carrier for the first planet gear, wherein the first planet gear carrier is configured for the unevenly distributed arrangement of a number N of planet gears at the angular positions φₙ (n=1 to N) about a gearing rotation axis of the first planetary gearing, with

$${φ}_{n} = round ( n \cdot \frac{{z}_{S} - {z}_{H}}{N} ) \cdot \frac{360 °}{{z}_{S} - {z}_{H}}$$

for n=1 to N, wherein the function round( ) specifies rounding to the nearest integer [symbol] .

According to a further aspect, a method for assembling at least one planetary gearing is provided. The at least one planetary gearing is assembled using a kit according to one of the embodiments described herein. The method comprises assembling a first planetary gearing using a first ring gear of the ring gears with the ring gear tooth count z_{H}, the first sun gear, the first planet gear carrier, and a number N of first planet gears, wherein the first planet gears are arranged at angular positions φₙ specified by the first planet gear carrier, distributed unevenly in the circumferential direction.

The terms “axial,” “radial,” and “circumferential” typically refer herein to the gearing rotation axis of the planetary gearing, unless otherwise specified.

Planetary gearings according to typical embodiments are used in drive trains in industrial drive technology, particularly in machine tools, packaging machines, industrial robots, lathes or milling machines, printing presses, handling and automation technology, medical technology, logistics, automotive engineering, or construction machinery. Typical planetary gearings can provide a reduction ratio for slow or fast speeds.

According to typical embodiments, the planetary gearing comprises a ring gear with a ring gear tooth count. The ring gear tooth count is typically also referred to herein as z_{H}. The ring gear tooth count is, according to common convention, a negative number (z_{H}<0). The ring gear tooth count is typically the number of teeth of an internal toothing of the ring gear. The internal toothing is typically designed to mesh with the planet gears of the planetary gearing. The ring gear is typically arranged with the internal toothing coaxial to the rotational axis of the planetary gearing. In typical embodiments, the ring gear is fixed. “Fixed” is to be understood here to mean that the ring gear is rotationally fixed relative to a housing of the planetary gearing. In particular, the ring gear may be rotationally fixed to a housing of the planetary gearing. In further embodiments, the ring gear may be formed integrally with the housing or integrally with a part of the housing.

According to embodiments, the planetary gearing includes a sun gear rotatable about the rotational axis of the planetary gearing. The sun gear has a sun gear tooth count, which is also referred to herein as z_{S}. The sun gear tooth count is, in accordance with common convention, a positive number (z_{S}>0). The sun gear is typically configured to mesh with planet gears of the planetary gearing, wherein the planet gears are arranged radially between the sun gear and the internal toothing of the ring gear. In typical embodiments, the gear ratio i of the planetary gearing is determined by the ring gear tooth count z_{H} and the sun gear tooth count z_{S}. Typically, the gear ratio i=(1+z_{H}/z_{S}), particularly when the ring gear is fixed. In typical embodiments, the planetary gearing has an integer gear ratio. For example, the gear ratio of a typical planetary gearing can be 3, 4, 5, 7, 8, or 10.

In typical embodiments, a planetary gearing comprises a number N of planet gears. The number N is typically a natural number greater than or equal to 2. In embodiments, the number N of planet gears is at least 3 or at most 8, in particular exactly 3 or exactly 4. The planet gears have planet rotation axes that are arranged in the circumferential direction around the gearing rotation axis at angular positions φₙ. Typically, the planetary gearing includes a planet gear carrier configured to support the planet gears at the angular positions φₙ so that they can rotate about a respective planet rotation axis, for example on axially aligned planet gear pins arranged at the angular positions φₙ.

Typically, the planet rotation axes are unevenly distributed in the circumferential direction around the gearing rotation axis. In particular, the angular positions φₙ are arranged unevenly in the circumferential direction around the gearing rotation axis. For the planetary gearings described herein with unevenly distributed planet gears, the following typically applies ( [symbol] : set of integers):

$$\frac{{z}_{S} - {z}_{H}}{N} ∉ ℤ .$$

Planetary gearings with such combinations of ring gear tooth count z_{H} and sun gear tooth count z_{S} typically do not allow for an even distribution of the planets, taking into account the number N of planet gears.

According to typical embodiments, the angular positions φₙ of the planet gears are determined by the formula

$${φ}_{n} = round ( n \cdot \frac{{z}_{S} - {z}_{H}}{N} ) \cdot \frac{360 °}{{z}_{S} - {z}_{H}}$$

for the values n=1 to N. The natural numbers from 1 to N are used as values of n to determine the angular positions φ₁ to ON of the individual planet gears. The angular positions φₙ of the planetary gears are each determined relative to a reference angle (zero angle). Typically, the angular position φ_{N}=360° corresponds to the angular position of the reference angle. The function round( ) specifies rounding to integers [symbol] . Round ( ) typically specifies a rounding function that rounds up if the first decimal place is greater than or equal to 5, and rounds down otherwise. In particular, the function round( ) can be used for a variable x using the Gaussian bracket └x┘ (also called the Gaussian, integer, or rounding function) and the rounding-up function └x┘ (also called the upper Gaussian bracket) as follows:

$$round ( x ) = \{ \begin{matrix}⌊ x ⌋ & for x - ⌊ x ⌋ < 0.5 \\ ⌈ x ⌉ & for x - ⌊ x ⌋ \geq 0.5\end{matrix}$$

Typically, after determining the angular positions φₙ of the planet gears, in particular before manufacturing the components for the planetary gearing, the planet gears are checked for clearance. The planet gears are free from collision if the center distance between two planet gears is greater than the pitch diameter of a planet gear. Checking the planet gears for freedom from collision typically ensures that the planet gears can be assembled. Typically, the planet gears are assembled without collision in the methods described herein, in particular to provide typical planetary gearings described herein.

In typical embodiments, there are angular distances Δφₘ (m=1 to N) between circumferentially adjacent angular positions φₙ (n=1 to N). The angular distances can be described in particular as Δφ₁=φ₁ for m=1, and Δφₘ=φₘ−φₘ₋₁ for m=2 to N. For example, for N=3, the angular distances Δφ₁=φ₁, Δφ₂=φ₂−φ₁ and Δφ₃=φ₃-φ₂ exist. In embodiments, at least two of the angular distances Δφₘ are equal.

According to embodiments, the angular distances Δφₘ differ from one another by angular deviations of less than 4°, in particular by angular deviations of less than 3°. Typically, the angular distances Δφₘ differ from one another by angular deviations greater than 2°. For example, the angular distances Δφₘ may differ from one another by angular deviations between 2° and 4°, or between 2° and 3°. In typical embodiments, the angular deviations are equal to a minimum division angle δ, wherein the minimum division angle d is determined as follows:

$$δ = \frac{360 °}{{z}_{S} - {z}_{H}} .$$

Typically, the angular intervals Δφₘ (m=1 to N) deviate from a theoretical, uniform angular interval Δψ=360°/N by less than 3°, in particular by less than 2°, and in some embodiments by less than 1°. The deviations or angular deviations described herein are to be understood as the magnitude of the difference between the quantities being compared.

In typical embodiments, the absolute value |z_{H}| of the ring gear tooth count is at least 108, in particular at least 135 or at least 140, or at most 162, in particular <at most 155 or at most 150. In embodiments, the value |z_{H}| of the ring gear tooth count is 144. A ring gear tooth count according to the embodiments described herein can, for example, be used in planetary gearings with a low-loss toothing, wherein the low-loss toothing comprises, in particular, the ring gear toothing, the planet gear toothing of the planet gears, and the sun gear toothing of the sun gear. Typical embodiments may, in particular, offer the advantage that planetary gearings with the same ring gear tooth count but with different integer gear ratios can be manufactured, even if a uniform distribution of the planet gears is not possible. The low-loss toothing may, for example, have a module of 0.45 mm to 1.75 mm, in particular to provide high efficiency of the planetary gearing, and in particular high profile overlap or high load-carrying capacity of the toothing. The low-loss toothing may be designed as helical toothing. The ring gear may have a pitch diameter of at least 35 mm or at most 230 mm. A planet gear bearing may be designed with needle rollers, particularly as a caged bearing.

According to typical embodiments, a kit for a plurality of planetary gearings is provided. A kit comprises gearing components for assembling planetary gearings. A typical kit described herein may also be referred to as a gearing kit or a modular gearing system. Typically, the plurality of planetary gearings comprises a first planetary gearing, which is to be assembled as a planetary gearing with planet gears arranged in a circumferentially uneven distribution according to one of the embodiments described herein. The first planetary gearing typically has a first gear ratio, in particular an integer gear ratio. The plurality of planetary gearings may comprise or consist of a plurality of identical first planetary gearings, or may comprise or consist of a series of planetary gearings described herein.

A typical kit comprises ring gears for the plurality of planetary gearings, in particular for the first planetary gearing. The ring gears are identical. The ring gears typically each have the same ring gear tooth count z_{H}, and in particular the same ring gear diameter. The ring gear diameter referred to here specifically means the ring gear inner diameter of the internal toothing. The ring gears typically have the same helix angle, typically of at least 6° and/or at most 12°. The ring gears may, in particular, each be configured in accordance with a ring gear described herein.

Typically, the kit comprises a first sun gear with the first sun gear tooth count z_{S} for the first planetary gearing. The first sun gear may, in particular, be configured in accordance with a sun gear described herein for a planetary gearing with planet gears distributed unevenly in the circumferential direction. In particular, the sun gear tooth count z_{S} may be selected such that, given a number N of planet gears, an even distribution of the planet gears is not possible.

According to typical embodiments, the kit comprises a first planet gear carrier for the first planetary gearing. The first planet gear carrier is typically configured for the unevenly distributed arrangement of a number N of planet gears at the angular positions φₙ (n=1 to N) about a gearing rotation axis of the first planetary gearing. For example, the first planet gear carrier may be configured to arrange planet gear pins at the angular positions φₙ distributed unevenly around the gearing rotation axis. The angular positions φₙ typically correspond to the angular positions φₙ of typical planetary gearings described herein, in which the planet gears are arranged in a non-uniform distribution.

Typically, the kit includes first planet gears for the first planetary gearing, in particular a number of at least N or at least 2·N first planet gears for one or more first planetary gearings. The first planet gears are typically configured to be mounted on planet gear pins of the first planet gear carrier. The first planet gears are typically configured to mesh, in an assembled state of the first planetary gearing, with the first sun gear and with a ring gear of the ring gears having the ring gear tooth count z_{H}. The first planet gears typically each have a first planet gear tooth count z_{P1}.

In typical embodiments, the plurality of planetary gearings comprises a series of planetary gearings, wherein the series comprises the first planetary gearing and a second planetary gearing. Typically, the ring gears of the kit are provided for all planetary gearings of the series with the same ring gear tooth count z_{H} and, in particular, with the same ring gear diameter. In particular, the ring gears are provided for the first planetary gearing and the second planetary gearing. Typically, the kit includes a second planet gear carrier, different from the first planet gear carrier, for the second planetary gearing. Typically, the second planet gear carrier has a uniform distribution of planets. In particular, the second planet gear carrier is configured for the uniformly distributed arrangement of a number Q of planet gears at angular positions φ_{q} (q=1 to Q) about a gearing rotation axis of the second planetary gearing, in particular with φ_{q}=q·360°/Q for q=1 to Q. The number Q of the second planet gears of the second planetary gearing may be equal to the number N of the first planet gears of the first planetary gearing. In further embodiments, the number Q of the second planetary gearing may differ from the number N of the first planetary gearing.

Typically, the kit includes a second sun gear with a second sun gear tooth count z_{S2} for the second planetary gearing. Typically, for the second planetary gearing with planetary gears evenly distributed in the circumferential direction:

$$\frac{{z}_{S} - {z}_{H}}{Q} ∈ ℤ .$$

This formula can also be described here as a condition for the uniform distribution of the planet gears. The second sun gear, tooth count z_{S2}, is typically different from the first sun gear tooth count z_{S}. Typically, the second sun gear has a diameter different from that of the first sun gear.

Typically, the kit includes second planet gears for the second planetary gearing, in particular a number of at least Q planet gears for the second planetary gearing. The second planet gears are typically arranged for mounting on the second planet gear carrier. Typically, the second planet gears are configured to mesh with one of the ring gears having a ring gear tooth count z_{H} and the second sun gear. The second planet gears typically each have a second planet gear tooth count z_{P2}. The second planet gear tooth count z_{P2} is typically different from the first planet gear tooth count z_{P1} of the first planet gears. Typically, the second planet gears each have a diameter different from that of the first planet gear. In typical embodiments, the toothings of the first planetary gearing and the second planetary gearing have an identical module and/or an identical helix angle, in particular the toothings of all planetary gearings in the series.

In typical embodiments, the second planetary gearing has a second gear ratio, specifically a second gear ratio that differs from the first gear ratio of the first planetary gearing. Typically, the second gear ratio is an integer ratio. In embodiments, the first planetary gearing and the second planetary gearing each have an integer gear ratio. In particular, the first planetary gearing may have a first integer ratio, and the second planetary gearing may have a second integer ratio different from the first integer ratio.

In embodiments, the kit for a series comprises respective planet gear carriers for planetary gearings with different gear ratios of the series, wherein the different gear ratios comprise at least two gear ratios from a group of integer gear ratios 3, 4, 5, 7, 8, and 10, and wherein the first planetary gearing has a first gear ratio of the at least two gear ratios. In particular, the different gear ratios of the series may comprise at least three, at least four, at least five, or all of the gear ratios in the group of integer gear ratios. In embodiments, the series may comprise several planetary gearings with planet gears distributed unevenly in the circumferential direction, in particular a first planetary gearing described herein and at least one further planetary gearing with uneven planet distribution. Typically, the series comprises at least one planetary gearing with planet gears distributed uniformly in the circumferential direction, in particular a second planetary gearing described herein. In addition to the second planetary gear, the series may include one or more additional planetary gearings with uniform planetary distribution.

A typical kit may offer the advantage that planetary gearings with different gear ratios can be assembled from a single kit, in particular by using ring gears with the same ring gear tooth count z_{H}. With a gear ratio such as the second gear ratio of the second planetary gearing, where an even distribution of the planet gears is possible given the number of planet gears (see the above condition for the even distribution of the planetary gears), an even distribution of the planet gears can be achieved. An even distribution of the planet gears is generally advantageous in terms of load distribution among the planet gears. With a gear ratio such as the first gear ratio of the second planetary gearing, where an even distribution of the planet gears is not possible given the number of planet gears (condition for the even distribution of the planetary gears not satisfied), an uneven distribution of the planet gears according to embodiments described herein can be selected. Typical embodiments provide, even with an uneven distribution, a distribution of the planet gears that is as uniform as possible in the circumferential direction, taking into account the mountability of the planetary gearing, and in particular, a load distribution and stress on the planet gears that is as uniform as possible.

Typically, the kit may include further components of the plurality of planetary gearings, for example, planet gear pins to be arranged or arranged on the respective planet gear carriers, on which the planet gears are to be mounted. Further components may include, for example, one or more housings for the plurality of planetary gearings, or bearings for the plurality of planetary gearings.

According to typical embodiments, a method for assembling at least one planetary gearing using a kit according to one of the embodiments described herein is provided. Typically, the method comprises assembling a first planetary gearing using a first ring gear of the ring gears with the ring gear tooth count z_{H}, the first sun gear, the first planet gear carrier, and a number N of first planet gears. The first planet gears are arranged at the angular positions φₙ specified by the first planet gear carrier, distributed unevenly in the circumferential direction.

In embodiments, the method includes assembling a second planetary gearing, in particular a second planetary gearing described herein. The second planetary gearing is typically assembled using a second ring gear of the ring gears with the ring gear tooth count z_{H}. The ring gear tooth count of the second ring gear is equal to the ring gear tooth count of the first ring gear. The second ring gear may be identical to the first ring gear. The second planetary gearing is typically assembled using a second sun gear, a second planet gear carrier, and a number Q of second planet gears. Typically, the second planet gear carrier has a uniform distribution of planets. The second planet gears are arranged in a circumferentially uniform distribution at the angular positions specified by the second planet gear carrier, for example at the angular positions φ_{q} described herein. In typical embodiments, the assembled planetary gearings, in particular the assembled first planetary gearing and the assembled second planetary gearing, have different integer gear ratios.

In known planetary gearings, an uneven distribution of the planet gears typically leads to uneven loading of the planet gears and the planet gear bearings. Compared to a theoretically uniform distribution, in planetary gearings with an uneven distribution, individual planet gears are typically subjected to lower loads, while other planet gears are subjected to higher loads. The more heavily loaded planet gears typically limit the transmissible torque of the planetary gearing. Typical embodiments may offer, for example, the advantage over planetary gearings known from the prior art that a deviation of the planetary distribution from the theoretically uniform planetary distribution is reduced, in particular is minimized. Minimizing the deviation from a uniform planetary distribution can lead to the exploitation of the maximum load-carrying capacity potential of the planetary gearing in the case of a non-uniform planet distribution. Furthermore, in typical embodiments, vibration excitation or noise generation from planetary gearings with uneven planet distribution can be reduced. Wear caused by uneven loading of the planet gears can be reduced. In typical embodiments, the concentricity of the planet gearing can be improved. Unbalance caused by the uneven distribution of the planet gears can be reduced. Typically, given the only slight deviation from a uniform planet distribution, balancing weights to compensate for the uneven planet distribution might not be required. Furthermore, in a typical assembly, the number of components can advantageously be kept low by using as many identical parts as possible in the assembly, in particular by using ring gears with the same ring gear tooth count. Planetary gearings described herein can typically be manufactured at lower cost compared to known planetary gearings.

### BRIEF DESCRIPTION OF THE DRAWINGS

Further advantages and features of preferred embodiments of the invention will be explained below on the basis of the appended drawings, in which:

FIG. 1 shows a schematic view of a planetary gearing according to a typical embodiment;

FIG. 2 shows a schematic sectional view of a planetary gearing according to a further typical embodiment; and

FIG. 3 shows a flow diagram of a typical method.

### DESCRIPTION OF EMBODIMENTS

Typical embodiments will be described below on the basis of the figures, wherein the invention is not restricted to the exemplary embodiments; instead the scope of the invention is determined by the claims. In the description of the figures, the same reference signs are used for identical or similar parts.

### Detailed Description

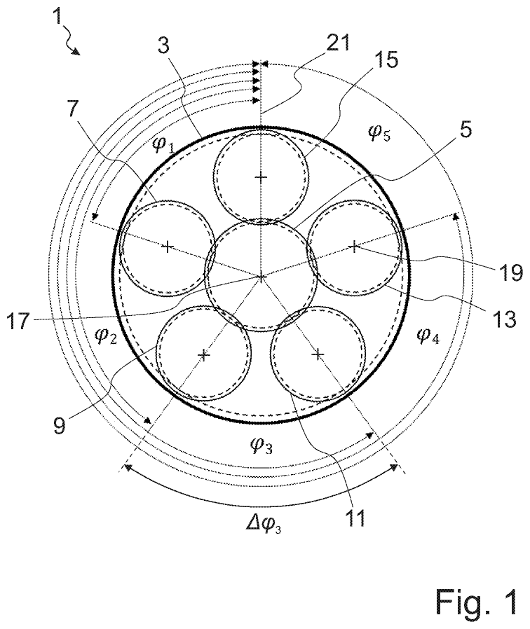

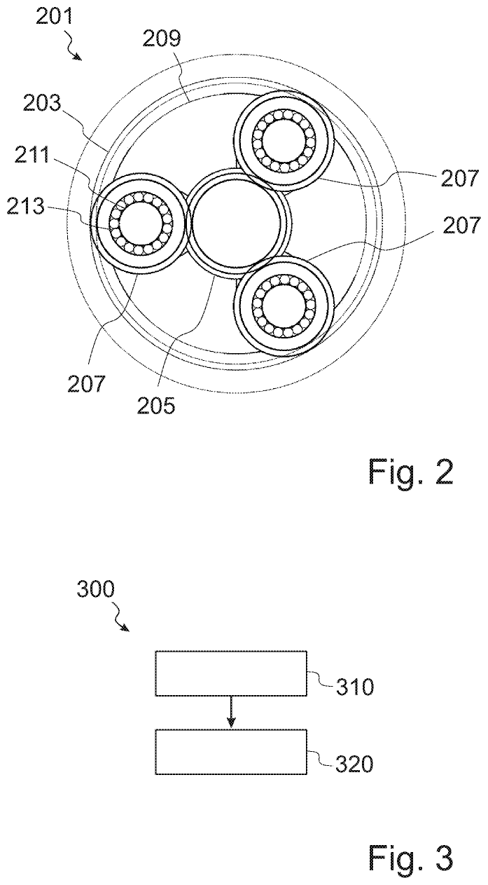

FIG. 1 shows a schematic representation of a typical planetary gearing 1, wherein in particular a cross-sectional view perpendicular to a gearing rotation axis 17 of the planetary gearing 1 is shown. The planetary gearing 1 comprises a sun gear 5 rotatable about the gearing rotation axis 17 with a sun gear tooth count z_{S}, a ring gear 3 arranged coaxially with the sun gear 5 with a ring gear tooth count z_{H}, and a number N of planet gears, which are arranged radially between the sun gear 5 and the ring gear 3. The planet gear toothings of the planet gears are each in mesh with the sun gear 5 and the ring gear 3. FIG. 1 shows, by way of example, N=5 planet gears, comprising a first planet gear 7, a second planet gear 9, a third planet gearing 11, a fourth planet gear 13, and a fifth planet gear 15. In further embodiments, a typical planetary gearing may have a different number of planet gears, as shown, for example, in FIG. 2. In FIG. 1, the planet gears 13 are mounted on planet gear pins so as to be rotatable about a respective planet rotation axis 19; these pins extending in the axial direction and being provided in a planet gear carrier (not shown in FIG. 1) of the planetary gearing 1.

The planet rotation axes 19 of the planet gears 13 are arranged in the circumferential direction around the gearing rotation axis 17 at unevenly distributed angular positions φₙ, which are determined using the formula for the angular positions φₙ according to the embodiments described herein. The angular positions φₙ, in particular φ₁, φ₂, φ₃, φ₄ and φ₅, are shown in FIG. 1 relative to a reference angle 21 (zero angle). In FIG. 1, the reference angle 21 corresponds to the angular position of the planet rotation axis 19 of the fifth planet gear 15. In particular, the angular position φ₅=360° corresponds to the reference angle 21 at 0°. Angular distances Δφₘ (m=1 to N) exist between the angular distances φₙ in accordance with the embodiments described herein. FIG. 1 shows, as an example, an angular distance Δφ₃=φ₃−φ₂ between the angular positions φ₃ and φ₂.

FIG. 2 shows a schematic cross-sectional view perpendicular to a gearing rotation axis of a planetary gearing 201 according to another typical embodiment. The planetary gearing 201 comprises a ring gear 203, a sun gear 205, and a number N=3 of planet gears 207. In FIG. 2, the planet gears 207 are each mounted on a planet gear pin 211 of the planetary gearing 201 so as to be rotatable about a planet rotation axis. In the embodiment of FIG. 2, needle rollers 213 are used to mount the planet gears 207 on the planet gear pins 211. The planet gear pins 211 extend in the axial direction and are fixedly connected to a planet gear carrier 209 of the planetary gearing 201. The planet rotational axes of the planet gears 207 and the planet gear pins 211 are arranged at angular positions φₙ distributed unevenly in the circumferential direction, in accordance with the embodiments described herein. In FIGS. 1 and 2, a deviation of the angular positions φₙ from a uniform distribution of angular positions is minimized, in particular to achieve the most uniform possible load distribution among the planet gears. The minimized deviation from a uniform planet distribution is barely discernible in the schematic representations of FIGS. 1 and 2.

According to a first exemplary embodiment, a planetary gearing 201 has a number N=3 of planet gears 207, for example as shown in FIG. 2. The ring gear 203 has a ring gear tooth count z_{H}=−144, and the sun gear 205 has a sun gear tooth count z_{S}=16. The condition for an even distribution of the planets is not met:

$$\frac{{z}_{S} - {z}_{H}}{N} = 53 , \overline{3} ∉ ℤ$$

The planetary gearing 201 has unevenly distributed angular positions φ₁=119.25°, φ₂=240.75° and φ₃=360.0°. The angular distances between the angular positions are Δφ₁=119.25°, Δφ₂=121.5° and Δφ₃=119.25°. The angular distances Δφ₁ and Δφ₃ are equal. The angular distance Δφ₂ differs from the other two angular distances by an angular deviation of 2.25° in each case. The angular deviation is equal to the smallest pitch angle δ=360°/(z_{S}−z_{H})=2.25°.

According to a second exemplary embodiment, a planetary gearing has a number N=4 of planet gears. The ring gear has a ring gear tooth count z_{H}=−110, and the sun gear has a sun gear tooth count z_{S}=24. The condition for an even distribution of the planets is not met:

$$\frac{{z}_{S} - {z}_{H}}{N} = 33 , 5 ∉ ℤ$$

The planetary gearing has unevenly distributed angular positions φ₁=91.34°, φ₂=180.00°, φ₃=268.66° and φ₄=360.00° (rounded values). The angular distances between the angular positions are Δφ₁=91.34°, Δφ₂=88.66°, Δφ₃=88.66° and Δφ₄=91.34° (rounded values). Any two of the angular distances are equal. The angular deviation of the angular distances is 2.69° (rounded value). The angular deviation is equal to the smallest pitch angle d. Due to the merely slight deviation from a uniform planet distribution, the most uniform possible load distribution among the planet gears can be achieved.

FIG. 3 shows a flow diagram of a typical method 300 for assembling at least one planetary gearing, in particular a first planetary gearing and a second planetary gearing described herein. Assembly is performed using a kit described herein for a series of planetary gearings. In block 310, a first planetary gearing is assembled using a first ring gear from a plurality of ring gears with the ring gear tooth count z_{H}, a first sun gear with a first sun gear tooth count z_{S}, a first planet gear carrier, and a number N of first planet gears. The first planetary gears are mounted on planet gear pins in the first planet gear carrier at angular positions φₙ (n=1 to N) distributed unevenly in the circumferential direction, in accordance with embodiments described herein. The first planetary gearing has a first integer gear ratio.

In block 320, a second planetary gearing is assembled using a second ring gear from the plurality of ring gears having the ring gear tooth count z_{H}, a second sun gear having a second sun gear tooth count z_{S2}, a second planet gear carrier, and a number Q of second planet gears. The second planet gears are mounted on planet gear pins in the second planet gear carrier, evenly distributed circumferentially at angular positions φ_{q} (q=1 to Q). The second planetary gearing has a second integer gear ratio that differs from the first integer gear ratio. The kit used in method 300 can be used in particular for assembling a series of planetary gearings with different integer gear ratios, wherein at least the ring gear can be used as a common component for assembling the series.

1. Planetary gearing (1, 201), comprising:
a ring gear (3, 203) with a ring gear tooth count z_{H},
a sun gear (5, 205) rotatable about a gearing rotation axis (17) of the planetary gearing (1) with a sun gear tooth count z_{S},
a number N of planet gears (207) with planet rotation axes (19), wherein the planet rotation axes (19) are arranged in the circumferential direction around the gearing rotation axis (17) at unevenly distributed angular positions on, wherein the angular positions φₙ are determined by the formula
$${φ}_{n} = round ( n \cdot \frac{{z}_{S} - {z}_{H}}{N} ) \cdot \frac{360 °}{{z}_{S} - {z}_{H}}$$
for n=1 to N, wherein the function round( ) specifies rounding to integers [symbol] .

2. Planetary gearing (1, 201) according to claim 1, wherein:
$$\frac{{z}_{S} - {z}_{H}}{N} ∉ ℤ .$$

3. Planetary gearing (1, 201) according to claim 1, wherein a value |z_{H}| of the ring gear tooth count is at least 108 and/or at most 162.

4. Planetary gearing (1, 201) according to claim 1, wherein a value |z_{H}| of the ring gear tooth count is 144.

5. Planetary gearing (1, 201) according to claim 1, wherein the planetary gearing (1) has an integer gear ratio.

6. Planetary gearing (1, 201) according to claim 1, wherein angular distances Δφₘ (m=1 bis N) exist between circumferentially adjacent angular positions φₙ (n=1 to N), and wherein the angular distances Δφₘ differ from one another by angular deviations of less than 4°.

7. Planetary gearing (1, 201) according to claim 6, wherein the angular deviations are less than 3°.

8. Planetary gearing (1, 201) according to claim 6, wherein the angular deviations are greater than 2°.

9. Planetary gearing (1, 201) according to claim 6, wherein the angular deviations are equal to a smallest pitch angle δ, and wherein the smallest pitch angle d is determined as follows:
$$δ = \frac{360 °}{{z}_{S} - {z}_{H}} .$$

10. Planetary gearing (1, 201) according to claim 1, wherein angular distances Δφₘ (m=1 to N) exist between angular positions φₙ (n=1 to N) adjacent in the circumferential direction, and wherein at least two of the angular distances Δφₘ are equal.

11. Planetary gearing (1, 201) according to claim 1, wherein the number N of planet gears is at least 3 and/or at most 8, in particular exactly 3 or exactly 4.

12. Kit for a plurality of planetary gearings, the plurality of planetary gearings comprising a first planetary gearing to be assembled as a planetary gearing (1, 201) according to claim 1, wherein the kit comprises:
ring gears for the plurality of planetary gearings, wherein the ring gears each have the same ring gear tooth count z_{H},
a first sun gear with the first sun gear tooth count z_{S} for the first planetary gearing, and
a first planet gear carrier for the first planetary gearing, wherein the first planet gear carrier is configured for the non-uniformly distributed arrangement of a number N of planet gears at the angular positions φₙ (n=1 to N) about a gearing rotation axis of the first planetary gearing, with
$${φ}_{n} = round ( n \cdot \frac{{z}_{S} - {z}_{H}}{N} ) \cdot \frac{360 °}{{z}_{S} - {z}_{H}}$$
for n=1 to N, wherein the function round( ) specifies rounding to the nearest integer [symbol] .

13. Kit according to claim 12, wherein the plurality of planetary gearings comprises a series of planetary gearings, wherein the series comprises the first planetary gearing and a second planetary gearing, wherein the ring gears of the kit are provided with the same ring gear tooth count z_{H} for all planetary gearings of the series, and wherein the kit further comprises:
a second planet gear carrier, different from the first planet gear carrier, with uniform planet distribution for the second planetary gearing.

14. Kit according to claim 13, wherein the first planetary gearing and the second planetary gearing each have an integer gear ratio.

15. Kit according to claim 13, comprising respective planet gear carriers for planetary gearings with different gear ratios of the series, wherein the different gear ratios comprise at least two gear ratios from a group of integer gear ratios 3, 4, 5, 7, 8, and 10, and wherein the first planetary gearing has a first gear ratio of the at least two gear ratios.

16. Method for assembling at least one planetary gearing using a kit according to claim 12, comprising
assembling a first planetary gearing using a first ring gear from the ring gears with the ring gear tooth count z_{H}, the first sun gear, the first planet gear carrier, and a number N of first planet gears, wherein the first planet gears are arranged at the angular positions φₙ specified by the first planet gear carrier, distributed unevenly in the circumferential direction.
